(19) United States
(12) Patent Application Publication
(10) Pub. No.: US 2016/0203576 A1
(43) Pub. Date: Jul. 14, 2016

(54) PROVIDING INFORMATION ABOUT A PROPOSED SERVICE FOR A USER BASED ON USER-SPECIFIC LOCATION INFORMATION

(71) Applicant: Uber Technologies, Inc., San Francisco, CA (US)

(72) Inventor: Kevin Novak, San Francisco, CA (US)

(21) Appl. No.: 14/991,152

(22) Filed: Jan. 8, 2016

Related U.S. Application Data
(60) Provisional application No. 62/101,060, filed on Jan. 8, 2015.

(51) Int. Cl. G06Q 50/30; G01C 21/34; G06Q 30/06

(52) U.S. Cl. CPC G06Q 50/30; G06Q 30/0631; G01C 21/3438

(57) ABSTRACT

A system and method for arranging a transport service is described. The system receives location information from a client device operated by a user, and based on the received location information, determines a set of information about each of at least two or more vehicle types. The system can transmit the set of information to the client device and determine a ranking of at least a first vehicle type and a second vehicle type based on one or more parameters. The system can determine that the user has indicated interest in making a transport request for the first vehicle type. In response to determining that the user has indicated interest in making a transport request for a vehicle type that is not the highest ranked vehicle type, the system can transmit a notification to the client device suggesting that the user make a transport request for another vehicle type.

### RELATED APPLICATIONS

This application claims the benefit of U.S. Provisional Patent Application No. 62/101,060, filed Jan. 8, 2015, titled PROVIDING INFORMATION ABOUT A PROPOSED SERVICE FOR A USER BASED ON USER-SPECIFIC LOCATION INFORMATION; the aforementioned application being incorporated by reference in its entirety.

### BACKGROUND

On-demand services can be requested and arranged through the use of mobile computing devices. For example, a user or a customer can operate a mobile computing device to make a request for a service and the service can be arranged on behalf of the customer. A service provider can be selected for the customer and the service provider can agree to perform the service using a respective computing device. Typically, such on-demand services may operate under a fixed pricing scheme.

### BRIEF DESCRIPTION OF THE DRAWINGS

FIG. 1 illustrates an example system to provide information to a client device based on real-time conditions and to arrange a service for the user.

FIG. 2A illustrates an example method for providing information to a client device based on real-time conditions.

FIG. 2B illustrates another example method for providing information to a client device based on real-time conditions.

FIG. 3 is a block diagram that illustrates a computer system upon which examples described herein may be implemented.

FIG. 4 is a block diagram that illustrates a mobile computing device upon which examples described herein may be implemented.

### DETAILED DESCRIPTION

Examples described herein provide for a service arrangement system that automatically notifies a user about an alternate type(s) or class(es) of service available for the user by ranking the types of service based on user-specific information and real-time conditions. A higher (or highest) ranked type of service can be deemed to be more beneficial to that user as compared to another type of service the user is potentially considering requesting or has requested (e.g., the higher ranked type may be cheaper and/or have a shorter wait time for the user). In one example, the notification about the alternate type of service may be particularly useful to the user in situations when the user may have overlooked such an option. In this manner, the user can have an opportunity to switch the types of service before making a final request for the service.

According to some examples, the service arrangement system (referred to herein as “the system”) can provide a platform to enable users to make requests for transport services through use of computing devices and can select drivers or vehicles to provide the transport services for those users. The system can receive, over one or more networks, location information from a client device that is operated by a user. The location information received from the client device can be a location data point (e.g., a latitude and a longitude coordinate, or a location point in another coordinate system) corresponding to the current location of the client device or a pickup location specified by the user (e.g., referred to herein as the “user's location,” the “user-specified location,” or the “pickup location”). Based on the received location information, the system can determine a set of information about each of at least two or more vehicle types or options that can provide a transport service for the user. Depending on implementation, the set of information can include information about which vehicle types are available at the user's location, the positions of the available vehicles within a specified distance of the user's location, pricing information for each of those vehicle types, and/or estimated time of arrival (ETA) information of each of those vehicle types to the user's location (e.g., in seconds, minutes, etc.). The system can transmit the set of information about each of at least two or more vehicle types to the client device to enable the user to view the information about the transport service associated with the user's location, such as through use of a client service application running on the client device.

The system can also determine, for the user, a user-specific ranking of at least a first vehicle type and a second vehicle type of these two or more vehicle types based on one or more parameters and based on at least some of the set of information. As described herein, a parameter can be a user-configurable parameter (e.g., configurable by a user of the system) that specifies how the ranking is to be performed by the system. For example, a parameter can specify that the ranking is to be based on the price of the two or more vehicle types and/or the ETA information of the two or more vehicle types (e.g., the system can determine the highest ranked vehicle type based on price and/or the highest ranked vehicle type based on ETA). Based on information received from the client device via user input (and/or information determined via the lack of user input), the system can determine whether the user has indicated interest in making a transport request for the first vehicle type. If the system determines that the user has indicated interest in making a transport request for a vehicle type that is not the highest ranked vehicle type for the user (e.g., a second vehicle type is the highest ranked vehicle type for the user based on the ranking), the system can automatically transmit, to the client device, a notification suggesting to or informing the user that the user should make a transport request for an alternate vehicle type as opposed to the previous vehicle type the user indicated interest in.

In another variation, if the user makes a transport request for a first vehicle type that is not the highest ranked vehicle type for that user, the system can automatically upgrade the user during the processing of the transport request by selecting a driver from a second vehicle type pool as opposed to selecting a driver from the first vehicle type pool (provided that the second vehicle type is ranked higher than the first vehicle type). In this manner, based on the information that is specific to the user's location, the service arrangement system can propose to the user that the user should make a request for a transport service using a particular vehicle type.

According to some examples, a system for providing transport services includes a network service, such as implemented by one or servers. In some examples, a system further includes mobile computing devices of users which execute a service application that repeatedly or continuously communicates with the network service in order to provide functionality and output for an end user.

In some examples, a system is implemented in which a location of a requester and/or pickup location is determined for purpose of suggesting a type of transport service for the user, based on multiple available types of transport services. The transport services can vary by type as a result of, for example, unit price, vehicle type, number of passengers (e.g., car pools) or other characteristics and classifications. For a current location and/or pickup location, the system can determine what types of transport services are available at the particular time. Based on a determined location, the system generates a suggestion for the user in selecting one type of transport service over one or more other transport services which are also available at the particular moment. More specifically, in generating the suggestion, the system determines a ranking for the available service types, based on one or more parameters that are dynamic and subject to change. In order to determine the ranking, the system implements one or more processes to obtain real-time, or near real-time information about each of the available service types, and the information is then used to rank the service types. A suggestion for a particular service type can be communicated to the requester via a mobile computing device of the requester.

In variations, the suggestion can be communicated after the user makes a selection of a transport type, such as when initiating a request for transport services. In such examples, the suggestion can provide an alternative to the selection of the user. In variations, the suggestion for a particular transport type can be made before the user initiates a transport request.

According to some examples, the system triggers processes on mobile computing devices of users, including requests and service providers. For example, the mobile computing device of each user and provider can include a service application which is configured to communicate location information for that device, as well as other information for enabling determination of activities such as (i) requests for transport services (e.g., communicated from requester device), (ii) indicators of potential requests for transport (e.g., communicated from requester device), (iii) acceptance of a transport request assignment (e.g., communicated from provider devices), or (iv) driving with or without rider (e.g., communicated from provider devices). For example, the system can provide a network service that receives location information from a service application that runs on the mobile computing device of the requester. The requester's service application can execute background processes to interact with a Global Positioning System (“GPS”) resource that is local on the device, in order to determine the location information of the mobile computing device, such that the location information communicated from the requester's mobile computing device can correspond to an actual physical location of the requester (e.g., determined through the GPS resource), or alternatively, to an actual pickup location for the requester. In some implementations, the service application can be configured through data provided from the network service to repeatedly access the GPS of the requester's mobile computing device in order to determine the current location of the requester (whether requester or service provider).

In some aspects, mobile computing devices of service providers who are present in a relevant geographic region for a given requester serve as information sources for the network service. In particular, service applications executing on the mobile computing devices can be used to obtain real-time or near real-time information that affects the ranking determination. One or more parameters for evaluating service providers of different service types can be determined based on the real-time information. For example, the proximity of service providers for a particular service type to a pickup location can be monitored to determine an ETA for a service provider of that type. As an addition or variation, the status of individual service providers can be monitored so that the ETA is determined for available service providers of the particular service type. Still further, a number of available service providers can be determined for purpose of determining fares or fare adjustments. Additionally, a number of requesters, or potential requesters who may potentially request services from available service providers, can be determined in order to determine potential fares or fare adjustments. Examples recognize that the obtained information can change significantly over even a relatively short period of time, and as such, the ranking of service types can also change. Moreover, information required for determining the ranking is not determinable to the requester as the requester could not know about (i) the locations of service provider in the region, (ii) the service state of the providers, and/or (iii) the number of requesters (and/or potential requesters) and the number of providers. A service such as described by various examples may determine such information by monitoring and determining the location of the requester, and by monitoring and determining the location and/or service state of service providers near the requester. In these and other regards, examples achieve a technical effect and benefit of facilitating the requester in performing a task, specifically a task of making a decision on the type of transport service to request. Still further, some examples achieve a more efficient use of resources, in that suggestions for type of transport to request can reduce the amount of time the requester spends using a mobile computing device when performing the task of making a transport request (e.g., conserving battery and computational resources). When examples rank service types by, for example, ETA (or trip duration), or suggest alternatives such as car pool services, examples also promote efficiency in automobile vehicle usage.

As used herein, a client device, a driver device, and/or a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A driver device can also correspond to taxi meters, in-vehicle computing devices of a transit object, or custom hardware, etc. The client device and/or the driver device can also operate a designated application configured to communicate with the service arrangement system.

Still further, while some examples described herein relate to transport services, the service arrangement system can enable other on-demand location-based services (for example, a food truck service, a delivery service, an entertainment service) to be arranged between individuals and service providers. The service arrangement system can also dynamically determine the price for other location-based services using location information associated with those service providers. These various services can be classified into different types, such as different types of foods for food truck or food delivery services, and the types can be ranked by the service arrangement system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. Examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

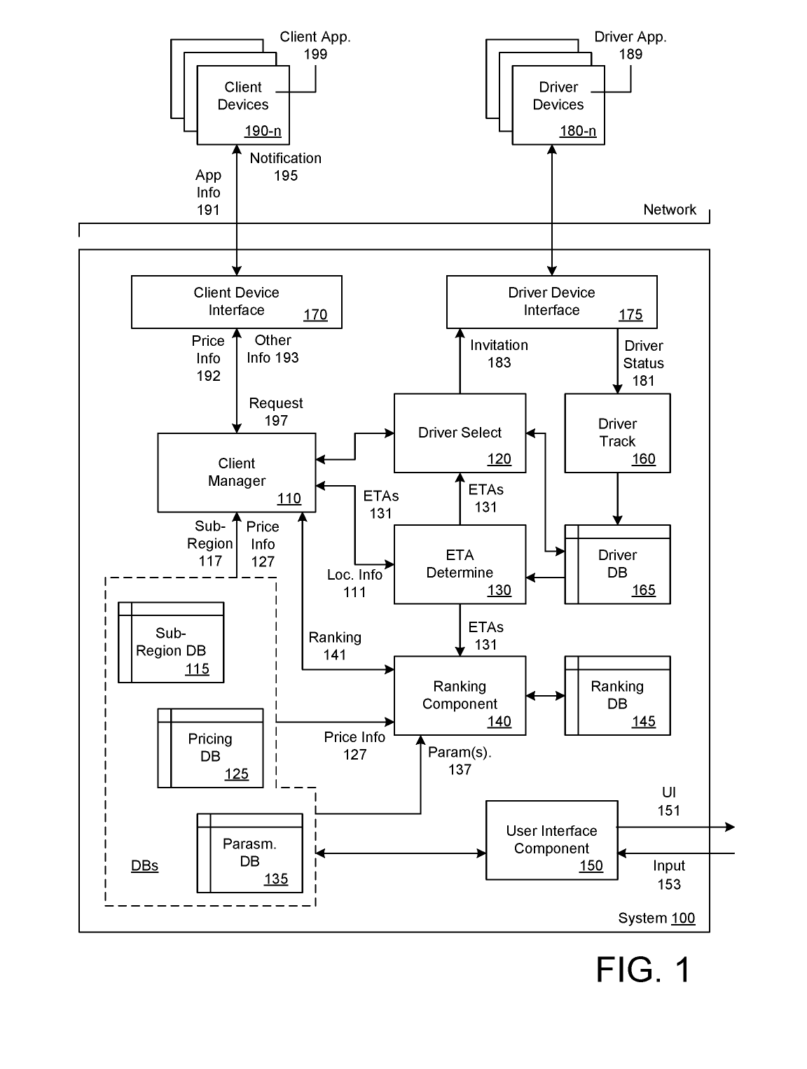

FIG. 1 illustrates an example system to provide information to a client device based on real-time conditions and to arrange a service for the user. The service arrangement system 100 (referred to herein as the “system 100”) can continuously/periodically determine information about the different vehicle types that can provide transport services for the user based on the user's location and can use information that is particular to the user's location to determine a ranking of the vehicle types for that user. Based on this ranking, the system 100 can propose, if necessary, a particular vehicle type that is best-suited for the user, thereby informing the user of a more/most cost-effective (e.g., cheaper) and/or faster (e.g., shorter wait time) option that is available for the user as compared to another vehicle type(s) that is available to the user or that the user may have been considering or may have even requested.

According to an example, the system 100 can include a client manager 110, a driver select 120, an estimated time of arrival (ETA) determine 130, a ranking component 140, a user interface component 150, a driver track 160, device interfaces 170, 175, and a plurality of databases. One or more components of the system 100 can be a part of a dispatch sub-system, such as the driver select 120, which can receive a request for a transport service from a user and perform a driver selection process for the user. The components of the system 100 can combine to programmatically determine information about each of two or more vehicle types for a transport service and determine a ranking for a user for purpose of notifying the user of a potentially higher ranked vehicle type option. Logic can be implemented with various applications (e.g., software) and/or with firmware or hardware of a computer system that implements the system 100.

Depending on implementation, one or more components of the system 100 can be implemented on a computing device, such as a server, laptop, PC, etc., or on multiple computing devices that can communicate with a plurality of driver devices 180 and a plurality of client devices 190 over one or more networks. In some examples, a computing device or system can operate or execute an application(s) to perform one or more of the processes described by the various components of the system 100. The system 100 can also be implemented through other computer systems in alternative architectures (e.g., peer-to-peer networks, etc.).

The system 100 can communicate, over one or more networks via a network interface (e.g., wirelessly or using a wire), with driver devices 180 (e.g., mobile computing devices operated by service providers, or in this example, drivers) using a driver device interface 175 and client devices 190 (e.g., mobile computing devices operated by clients or users/customers) using a client device interface 170. The device interfaces 170, 175 can enable and manage communications between the system 100 and each of the driver and client devices 180, 190. In some examples, the driver devices 180 and the client devices 190 can individually operate a respective service application (e.g., a designated driver application 189, a designated client application 199) that can interface with the device interfaces 170, 175 to communicate with the system 100. According to some examples, the applications can include or use an application programming interface (API), such as an externally facing API, to communicate data with the device interfaces 170, 175. The externally facing API can provide access to the system 100 via secure access channels over the network through any number of methods, such as web-based forms, programmatic access via RESTful APIs, Simple Object Access Protocol (SOAP), remote procedure call (RPC), scripting access, etc.

According to an example, a user can operate the client application 199 on his or her client device 190 in order to view information about a transport service and/or to make a request for a transport service to the system 100. When the user launches or opens the client application 199 on the client device 190 (e.g., turns on the client application 191 from an off or suspended state), the client application 199 can provide application information 191 to the system 100 over one or more networks (e.g., via cellular and/or Wi-Fi network). The application information 191 can include user-specific information, such as a user identifier and/or password, a device identifier, the application version information, and/or location information corresponding to the current location of the client device 190. In one example, the client application 199 can determine the current location of the client device 190 by communicating with a global positioning system (GPS) receiver of the client device 190. Once launched, the client application 199 can periodically provide the application information 191 (e.g., some or all of the above-listed information, depending on implementation) to the system 100 while it continues to run on the client device 190 (e.g., is operated by the user and is not in a suspended or off state).

The client application 199 can also provide other application information 191 periodically and/or intermittently in response to user input and interaction with the client application 199. For example, the user can interact with a user interface of the client application 199 to select a specific pickup location as opposed to using the current location of the client device 190 as the pickup location. The user can input an address, a street intersection, a landmark, a store name, etc., or move a graphic pin or indicator on a map displayed on the user interface to specify the pickup location. In this manner, each time the user inputs a different pickup location on the client application 199, the client application 199 can provide the location information corresponding to the user-specified location to the client manager 110 of the system 100 (e.g., individually or as part of the application information 191). In some examples, the user can also specify a destination location on the client application 191, and the client application 199 can provide the destination location information to the system 100.

When the client manager 110 receives the location information corresponding to the user's location from the client device 190 (e.g., the current location of the client device 190 or the user-specified pickup location), the client manager 110 can determine information about the transport service that is pertinent to the user's location to the client device 190, such as a set of information about each of two or more vehicle types for that user. For example, depending on which neighborhood, city, metropolitan area, county, state, country, etc., the user's location is located in, different vehicle types can be available to provide transport service for the user (e.g., can be requested by the user at the user's location). Similarly, the price for a vehicle type may vary depending on the user's location. In some cases, one vehicle type (or no vehicle types) may be available in a geographic region, while multiple vehicle types (e.g., four or five) may be available in another geographic region. The system 100 can store information about which vehicle types are available in which geographic regions in a database accessible by the system 100.

According to an example, in response to receiving the location information from the client device 190, the client manager 110 can use the location information to determine which geographic region (and/or which sub-region of a plurality of sub-regions of the geographic region) the user's location is positioned in. As referred to herein, a geographic region can correspond to an area of a city, a metropolitan area, a county, a region covering multiple cities, etc., in which a user can request the transport service using the client device 190 and/or in which the transport service is made available by the system 100. A geographic region can also be divided into smaller sub-regions so that the geographic region includes a plurality of sub-regions that are identified using a plurality of location data points. For example, the system 100 can specify a plurality of sub-regions for a geographic region corresponding to San Francisco, Calif., a plurality of sub-regions for a geographic region corresponding to San Jose, Calif., a plurality of sub-regions for a geographic region corresponding to New York City, N.Y., and so on. Each sub-region can be identified, for example, using three or more location points that define a boundary or perimeter of that sub-region. The information about the sub-regions can be stored in a sub-region database 115 as sub-region entries.

In some examples, a sub-region entry can include an identifier corresponding to the sub-region and a plurality of location data points that specify the sub-region, and/or can be associated with or include (i) information about the vehicle types that are available in the sub-region (or the geographic region) and/or (ii) price information for those vehicle types (e.g., default prices for those vehicle types in the sub-region or the geographic region). In one example, the system 100 can programmatically determine or designate a plurality of sub-regions for a given geographic region based on historical information of previously arranged transport services (e.g., such as the position of drivers in the geographic region when those drivers accepted invitations to provide transport for users, and the pickup locations of those users in the geographic region) and/or based on user input provided by an administrator of the system 100 (via the user interface component 150). The client manager 110 can access the sub-region database 115 and search the sub-region entries, for example, to determine the particular sub-region 117 for the user's location and to determine which vehicle types are available in that sub-region.

The client manager 110 can also access a pricing database 125 to determine price information for the individual vehicle types that are available in the sub-region 117 (e.g., for those vehicle types that are available at the user's location). For example, the price for the transport service can vary depending on the geographic region in which the user's location is positioned in (e.g., transport service in San Francisco, Calif. can be generally more expensive than transport service in Topeka, Kans.). In addition, the price for the transport service can vary based on the different vehicle types within a given sub-region. For each geographic region and/or sub-region (e.g., such as those that are specified in the sub-region database 115), the pricing database 125 can store pricing information for each individual vehicle type that is available in that geographic region and/or sub-region. According to examples, the pricing information can include a default price(s) for each vehicle type in a region or sub-region.

As used herein, a default price can correspond to one or more of a flat amount for the transport service, a minimum amount for the transport service, an initial amount for the transport service, an amount per distance traveled to be added to the initial amount, an amount per duration of time to be added to the initial amount, and/or other fees. In a particular region or sub-region, for example, a default price for a vehicle type can depend on the quality, the luxury, or the size of the vehicle type (e.g., low-cost vehicle type, larger vehicle type that sits more than four, higher-end vehicle type, luxury vehicle type, a family vehicle type, etc.) and can be designated by an administrator of the system 100 (e.g., via the user interface component 150). For example, the user interface component 150 can provide user interfaces 151 to enable the administrator of the system 100 to provide input 153 to configure, view, edit, delete, and/or modify one or more entries, records, information stored in any of the databases accessible by the system 100, including the sub-region information in the sub-region database 115, one or more parameters in the parameters database 135, and/or the default pricing information for individual vehicle types in different geographic regions or sub-regions.

The pricing database 125 can also store pricing information that includes dynamically adjusted prices for vehicle types in individual geographic regions or sub-regions. According to some examples, the system 100 can include a pricing component (not shown in FIG. 1 for purpose of simplicity), which can periodically determine and/or update the price for the individual vehicle types in different geographic regions or sub-regions. For example, for each sub-region of a geographic region, the pricing component can periodically determine a price for each of multiple vehicle types based on real-time or close to real-time information about drivers of those multiple vehicle types in that sub-region (e.g., location information and/or status information of those drivers) and/or based on real-time or close to real-time information about users operating client applications 199 in that sub-region. The drivers' information can be periodically updated and stored in the driver database 165 by the driver track 160.

For example, the driver track 160 can receive driver status information 181 from the plurality of driver devices 180 via the driver device interface 175. The driver status information 181 can specify the status of a particular driver, such as whether the driver is (i) on-duty and available (e.g., is waiting for a transport invitation from the system 100), (ii) currently providing transport to a user and unavailable, (iii) in progress to a pickup location to provide transport but has not yet provided transport (e.g., has accepted a transport request and is in route/is progressing to the pickup location of the user), (iv) is within a predetermined distance of the pickup location, and/or (v) non-active or off-duty (e.g., is not working, is having vehicle problems, etc.). The status information 181 can also include respective time and location information (which can be determined by a GPS component of the driver's device 180), such as the time and location when the driver has completed providing transport service or when the driver has accepted a transport request. The driver applications 189 running on the driver devices 180 can provide the status information 181 (e.g., status and/or location and time information) periodically and/or intermittently based on driver input on the driver applications 189.

In another example, the driver track 160 can automatically determine the status information 181 of a driver based on the current location of the driver device 180 and the specified pickup location (e.g., whether the driver is within a predetermined distance of the pickup location). In addition, the driver track 160 can also receive (e.g., periodically) current location information of the driver devices 180 separately and/or as part of the status information 181. The driver track 160 can update the driver database 165 with the drivers' status information in real-time for each respective driver (using the driver identifiers). In this manner, the pricing component can continually (e.g., periodically) receive or retrieve driver status information 181 and location information of drivers for purposes of determining or adjusting prices in geographic regions and/or sub-regions.

For individual sub-regions, the pricing component can increase or decrease the price from a previous price based on the real-time information. In one example, for each sub-region, the pricing component can determine the price for the transport service for a particular vehicle type based on a number of drivers of that vehicle type that are in progress to a respective pickup location in that sub-region and based on a number of drivers of that vehicle type that are available but not in progress in that sub-region. As an addition or an alternative, the pricing component can also use the location information of users operating client devices 190 in that sub-region that have not yet requested transport services but are operating the client application 199 and/or location information of users that are currently receiving transport service in that sub-region. The pricing component can also adjust the price relative to the default price(s).

For example, for a given sub-region, the pricing component can determine a price multiplier for each vehicle type based on real-time conditions, such as the location and status of drivers of that vehicle type in that sub-region and/or the location and status of users in that sub-region (e.g., as determined from information received from the client devices operated by the users). The price multiplier can be a value that is multiplied to each respective vehicle type's default price(s) (e.g., multiplied to any of one or more of a minimum amount for the transport service, an initial amount for the transport service, an amount per distance traveled to be added to the initial amount, an amount per duration of time to be added to the initial amount, and/or other fees). In this manner, when a sub-region is undersupplied for a vehicle type, the price multiplier can be increased for that sub-region (e.g., 1.4×, 2.2×, etc.) and when the sub-region is oversupplied for a vehicle type, the price multiplier can be decreased from the previous price multiplier or set to the lowest price multiplier (e.g., 1× or even lower, in some instances). By enabling prices to be dynamically adjusted for vehicle types, in some situations, a typically low-cost (and four-seater) vehicle type may be more expensive than a typically high-end, luxurious (e.g., a six-seater or black car) vehicle type in a sub-region at a given instance in time.

The pricing database 125 can store, for each vehicle type in a particular geographic region or sub-region, the pricing information as both the default price(s) and the current price multiplier that can be periodically updated by the pricing component. Depending on implementation, the pricing database 125 can correspond to multiple pricing databases, but is shown as only one database in FIG. 1 for purpose of simplicity. For example, each geographic region can be associated with an individual pricing database 125. Similarly, any described database of FIG. 1 can correspond to multiple databases in different variations.

Referring back to the client manager 110 of FIG. 1, the client manager 110 can also provide the location information 111 of the user's location (e.g., the current location of the client device 190 or the user-specified pickup location) to the ETA determine 130 in order to determine the ETA 131 of each of the two or more vehicle types to the user's location. The ETA determine 130 can access the driver database 165 and/or a mapping database that stores mapping information (not illustrated in FIG. 1 for purpose of simplicity) to determine a set of drivers that are available and located in a predetermined distance from the location information 111. In one example, the ETA determine 130 can include or communicate with a routing machine or engine that uses map data, the location information 111, and the position of available drivers from the driver database 165 to determine the ETA for each of the drivers of the individual vehicle types to the user's location (or in alternative implementations, determine the distance to be traveled to the user's location). The ETA for a vehicle type can correspond to the shortest ETA of the set of drivers, the longest ETA of the set of drivers, the averaged ETA of the set of drivers, or the averaged ETA of a sub-set of drivers having the shortest ETA of the set of drivers. For example, if there are two vehicle types (Type1, and Type2) available in the given region or sub-region of the user's location, the ETA determine 130 can determine the ETA of each of the two vehicle types to the user's location (e.g., 3 minutes to the user's location for Type1, 5 minutes to the user's location for Type2).

For an individual user with the specified user's location, the client manager 110 can determine the available vehicle types for the user, the price information 127 for the vehicle types, and the ETAs 131 for the vehicle types at the user's location. The client manager 110 can provide the user's location-specific price information 192 to the client device 190 of the user and provide other information 193 to the client device 190. The other information 193 can include information about the ETAs 131 of the vehicle types as well as position information of drivers within a predetermined distance from the user's location, so that the client application 199 can display graphics indicating the position of the vehicles on a map user interface of the client application 191. The client application 199 can use the price information 192 and the other information 193 to display, for a particular vehicle type, the corresponding information for that vehicle type on a user interface of the client application 199. The client application 199 can also store the price information 192 and display graphics/content/text of the price information 192 in response to user input. In this example, when the user selects a first vehicle type, graphics of vehicles can be displayed for that first vehicle type along with the ETA 131 of the first vehicle type. The user can also select a feature to view the pricing information 192 of the first vehicle type. If the user selects a second vehicle type, graphics of vehicles can be displayed for the second vehicle type along with the ETA of the second vehicle type, and so forth.

The client manager 110 can periodically provide the price information 192 and other information 193 (e.g., information about the ETAs 131) to the client device 190 so that the client application 199 can periodically update the information on the user interface(s) for the user. As an addition or an alternative, the client manager 100 can provide the information in response to receiving status information 191 from the client device 190 corresponding to user input to view the price, for example. In this manner, the client manager 110 can provide a set of information that is pertinent to the user's location each time the user updates or changes the current location or the pickup location. The client application 199 can display the most up-to-date information for the user.

The system 100 can also use the set of information (e.g., pricing and ETA information) about each of at least two or more vehicle types to determine a ranking of the vehicle types for the user for purpose of potentially proposing a particular vehicle type for the user. For example, the ranking component 140 can use the price information 127 of the individual vehicle types that are available for the user's location and/or the ETAs 131 of the individual vehicle types to the user's location in order to determine a ranking of the two or more vehicle types with respect to each other. The ranking component 140 can determine the ranking 141 for the user based one or more parameters 137 from the parameters database 135. The one or more parameter 137 can instruct how the ranking component 140 is to perform the ranking.

In one example, one or more parameters 137 can specify that the ranking component 140 is to determine the ranking 141 for the user (i) based on the price information 127 of the vehicle types, (ii) based on the ETA 131 of the vehicle types, or (iii) based on both the price information 127 and the ETA 131. In addition, one or more parameters 137 can specify how the price information 127 and the ETA 131 can be weighted (e.g., the price is weighted more heavily (75%) than the ETA (25%)) or set price thresholds or time thresholds for the ranking. According to other examples, one or more parameters 137 can specify that the ranking component 140 is to determine the ranking 141 differently based on different geographic regions or sub-regions. Still further, other parameters 137 can instruct the ranking component 140 to determine the ranking 141 for only a sub-set of vehicle types from a larger set of available vehicle types (e.g., exclude a vehicle type(s) from ranking).

In some other examples, one or more parameters 137 can specify that the ranking 141 for a user is to be performed only when the price for at least one of the vehicle types or a particular vehicle type is equal to or above a threshold price (e.g., the price multiplier has to be greater than 1× or 1.5×, etc.). For example, the ranking component 140 may not determine a ranking 141 for a user unless certain real-time or close to real-time conditions exist. In another example, one or more parameters 137 can specify a predetermined ranking or hierarchy of vehicle types, such that when the prices for two or more vehicle types are equal or substantially equal, for example, the ranking component 140 can rank the vehicle types based on the predetermined rankings. For example, the high-end luxurious vehicle type can be predetermined to be ranked higher than the low-cost vehicle type, so that in the event that (i) these two vehicle types are equal or substantially equal in price (one current price is within a specified percentage, such as 90%, of the other current price), and (ii) the ranking for the user is to be based on price, the ranking component 140 can rank the high-end luxurious vehicle type to be higher than the low-cost vehicle type.

Referring to the previous example, for purpose of simplicity, two vehicle types are available at the user's location, Type1 and Type2. Based on the one or more parameters 137, the ranking component 140 can determine, for the user, that Type2 is to be ranked higher than Type1. The ranking component 140 can store the ranking 141 in the ranking database 145 and continuously/periodically update the ranking 141 for the user based on updated price information 127 and updated ETA information 131. The ranking component 140 can also continuously/periodically provide the ranking 141 to the client manager 110 each time a new ranking is determined.

According to some examples, the client manager 110 can determine whether the user has indicated interest in making a transport request for a particular vehicle type based on information received from the client device 190 of the user or information determined by the client manager 110. In one example, the client manager 110 can receive information from the client device 190 indicating that the user has provided specific user input on the client application 199 that reflects the user's interest in making a transport request. The user may have specified a particular vehicle type and may have selected a first selectable feature (e.g., “Set Pickup Location” or “Request Trip”) on the user interface of the client application 199 that causes the client application 199 to provide a second confirmation user interface, for example, that allows the user to review the transport request before confirming (e.g., a “Confirm Request” feature can be displayed on the second confirmation user interface). In another example, the client manager 110 can receive information from the client device 190 indicating that the user has confirmed and made the transport request for a particular vehicle type before quickly canceling the transport request within a predetermined duration of time.

Still further, in another example, the client application 199 can continue to provide application information 191 to the client manager 110 (e.g., periodically) indicating that the service application 199 is running on the client device 190, but the client manager 110 may not have received, for a specified duration of time, any information indicating that the user has provided input to make a transport request. The client manager 110 can determine the last vehicle type the client application 199 has displayed on the client device 190. In such case, the client manager 110 can determine that the user is considering making a transport request for the last vehicle type, but has not yet quite decided on doing so (e.g., the user may be viewing content on the client application 199 but may have not yet selected a feature to make a transport request).

According to an example, when the client manager 110 determines that the user has indicated interest in making a transport request for a particular vehicle type, the client manager 110 can determine whether that vehicle type is the highest ranked vehicle type for that user. The client manager 110 can use the most recent ranking 141 for the user received from the ranking component 140 (and/or retrieved from the ranking database 145) to check if the vehicle type that the user has indicated interest in is the highest ranked vehicle type for that user. If the user has indicated interest in making a transport request for a vehicle type that is the highest ranked vehicle type for that user, the client manager 110 does not provide any additional information or notification to the client device 190. In another example, the client manager 110 can determine the ranking(s) for the user and initially display information of the highest ranked vehicle type(s) for the user. In such example, the client application can display a feature to select a first vehicle type (e.g., one that is the highest ranked vehicle type for the user based on ETA) and/or a feature to select a second vehicle type (e.g., one that is the highest ranked vehicle type for the user based on price), with the feature(s) including corresponding information indicating the context as to why the vehicle type(s) is proposed for the user. The information for the first vehicle type can state that it is X minutes faster (relative to the other vehicle type(s), such as relative to the second vehicle type) while the information for the second vehicle type can state that it can save the user money or that it is Y amount or percentage cheaper (relative to the other vehicle type(s), such as relative to the first vehicle type).

On the other hand, if the user has indicated interest in making a transport request for a vehicle type that is not the highest ranked vehicle type for the user (e.g., referring to the previous example, the user specified Type 1, but Type2 is ranked higher than Type1), the client manager 110 can generate and transmit information, e.g., such as a notification 195, to the client device 190 to propose or suggest to the user that the user should make a transport request for the highest (or higher) ranked vehicle type. The notification 195, for example, can include programmatically generated content that is specific to the ranking 141 and/or the vehicle type (e.g., in this example, Type2). The notification 195 can also include information about the difference in cost and/or price as part of the content. For example, the notification 195 can be displayed by the client application 199 before the user can confirm or make a request for the transport service. In this manner, the system 100 can use location information associated with the user and real-time conditions, such as pricing information for different types of service, to propose a particular service that is suitable for a specific user. The system 100 can provide the user with beneficial information that the user may have overlooked and provide the user with an option to switch services before finalizing the transport request.

The user can then make a transport request 197 for a particular vehicle type at the user's discretion. When the client manager 110 receives the request 197, the client manager 110 can provide information from the request 197 to the driver select 120 (e.g., the pickup location information, the vehicle type, and/or the destination location information). The driver select 120 can use the driver information from the driver database 165 and/or the ETAs 131 of the available drivers within a predetermined distance from the pickup location of the user, and select a driver to perform the transport service for the user. The driver select 120 can then transmit an invitation 183 to the selected driver's driver device 180, which the driver can either accept or reject. The driver select 120 can provide information about the selected driver to the client manager 110 so that the client manager 110 can provide information about the selected driver to the client device 190.

As an addition or an alternative, the client manager 110 may determine if the user has made a transport request 197 for a vehicle type that is the highest ranked vehicle type after it receives the transport request 197. In such an example, if the client manager 110 receives the transport request 197 from the client device 190 for a vehicle type that is not the highest ranked vehicle type (e.g., Type1), the client manager 110 can then transmit the notification 195 to the client device 190 to inform the user that a highest (or higher) ranked vehicle type (e.g., Type2) is available and that the system 100 is selecting a driver for the highest ranked vehicle type (e.g., that the system 100 is to process the user's transport request 197 with the highest ranked vehicle type). Such a notification 195 can include content/text/graphics that indicate why the alternate vehicle type (Type2) is ranked higher for the user (e.g., is cheaper by X amount, or is Y minutes shorter wait, or is very similar in cost at the moment but is more luxurious or spacious, etc.).

In another example, the notification 195 can enable the user to cancel the request or revert the request back to the originally specified vehicle type (or confirm the new alternate, higher ranked vehicle type). For example, the user can be given a predetermined duration of time to cancel or change the transport request 197 or allow the system 100 to continue with the driver selection process with the highest (or higher) ranked vehicle type. If the client manager 110 determines that the user wants to continue with the transport request of the highest (or higher) ranked vehicle type (Type2), the client manager 110 can provide information about the transport request 197 to the driver select 120, but specify that the user requested Type2 as opposed to Type1.

According to an alternate implementation, components of the system 100 can be implemented on the client application 199 of the client device 190 so that the client application 199 can perform at least some of the operations described with respect to FIG. 1. For example, the client application 199 can include a ranking component that determines the ranking for the user based on the set of information of each of multiple vehicle types received from the system 100, including ranking at least a first vehicle type and a second vehicle type with respect to each other. The client application 199 can implement a local client manager that determines whether the user has indicated interest in requesting transport for the first vehicle type based on what content is displayed by the client application 199 and/or based on user input (or lack of user input) on the client application 199. The client application 199 can generate and display a notification to the user if the local client manager determines that the user has indicated interest in requesting transport for the first vehicle type when the second vehicle type (or other vehicle type) is ranked higher for the user at the user's location.

Methodology

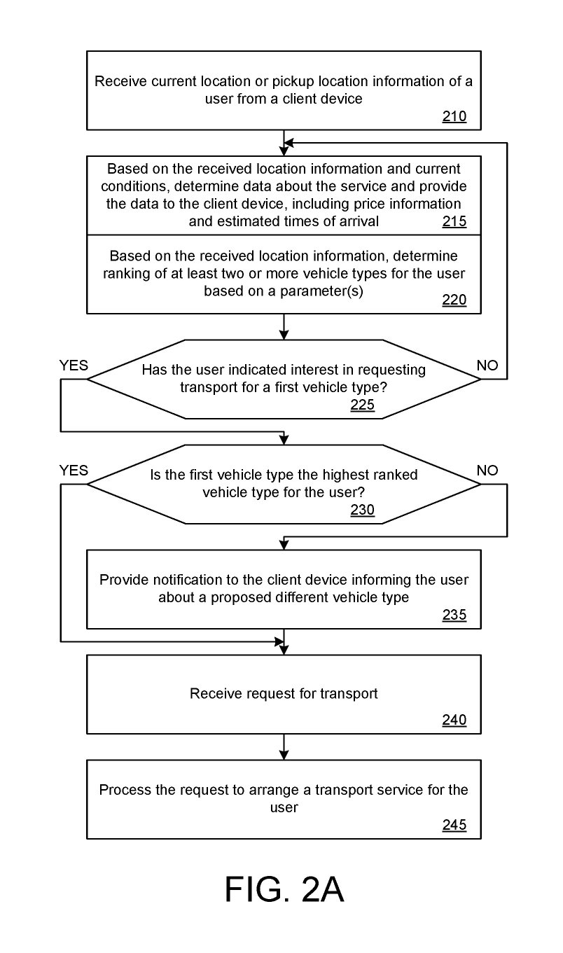

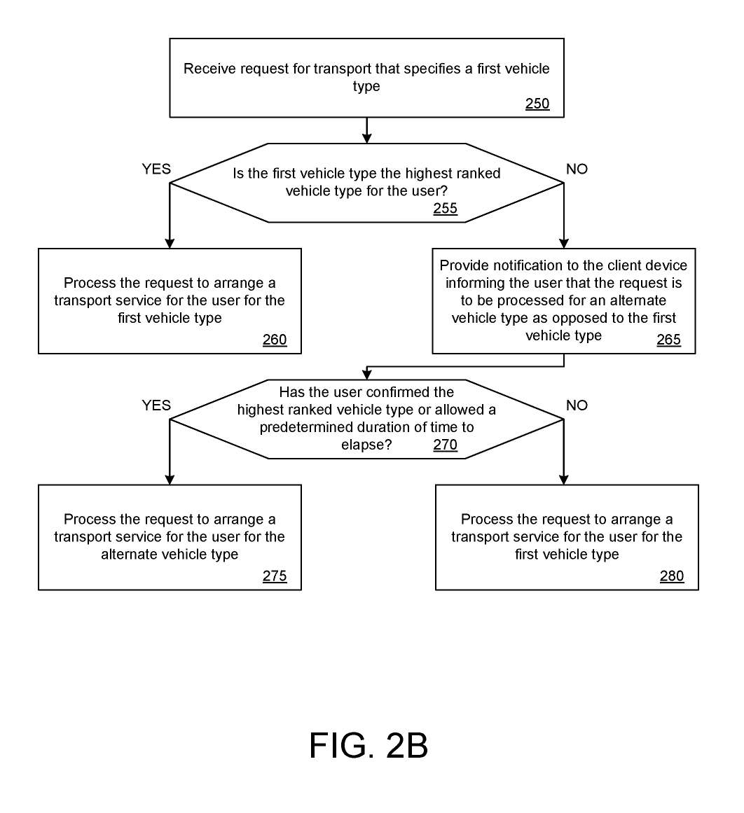

FIG. 2A illustrates an example method for providing information to a client device based on real-time conditions. A method such as described by an example of FIG. 2A can be implemented using, for example, components described with an example of FIG. 1. Accordingly, references made to elements of FIG. 1 are for purposes of illustrating a suitable element or component for performing a step or sub-step being described.

Referring to FIG. 2A, the system 100 can receive the current location information or a pickup location information of a user from a client device (e.g., the current location information or the pickup location information can be referred to as the user's location for purpose of simplicity) (210). The client device can operate a client service application that can determine the current location by interfacing with the GPS receiver of the client device or can enable the user to provide user input to specify a pickup location for purpose of determining information about a transport service and/or to make a request for the transport service. For example, the location information can be a GPS-based data point (e.g., a latitude and longitude coordinate), a point on a different geo-coordinate system, or an address (e.g., text string). In one example, the client application can provide the current location information to the system 100 when the service application is opened or launched from an off or suspended state (and then provide the current location information periodically to the system 100), and/or can provide the pickup location information each time the user specifies a different pickup location on the user interface of the client application. According to an example, the system 100 can initiate the method described in FIG. 2A each time it receives a new or different location information from the client device.

Based on the received location information, the system 100 can determine data about the transport service for the user and/or provide the data to the client device (215). The data can include price information for each of multiple vehicle types that are available for the user at the user's location and/or the ETA of each of the multiple vehicle types to the user's location (e.g., in minutes, seconds, etc.). The client application running on the client device can use the data to display information about the transport service on a user interface of the client application. For example, the system 100 can determine that, for the user's location, two vehicle types are available to provide transport services for the user, Type1 and Type2. Type1 can be a low-cost vehicle type and Type2 can be a high-end luxury vehicle type (or a larger six-seater vehicle type) in this example. For purpose of simplicity, in the sub-region or geographic region of the user's location, the default price for Type1 can be $5 minimum, $2 base amount, $0.25/minute, and $1/mile, while the default price for Type2 can be $8 minimum, $3 base amount, $0.45/minute, and $2/mile.

At the time the system 100 receives the location information from the client device, the system 100 can determine a set of information about each of the multiple vehicle types that are available at the user's location, including the price for each vehicle type at that time and/or the ETA of each vehicle type to the user's location. In some examples, the price for individual vehicle types can be dynamically adjusted in a given sub-region of the user's location based on real-time conditions. Referring to the previous example, while Type1 generally has a lower default price than Type2, at this time, the current locations and statuses of drivers and/or users in the sub-region of the user's location may have caused the price of Type1 to be dynamically increased by a price multiplier of 3×, while the price of Type2 may have remained the same. In addition, in this example, the ETA of Type1 to the user's location may be 2 minutes and the ETA of Type2 to the user's location may be 6 minutes.

Based on at least some of the determined set of information and based on one or more parameters, the system 100 can determine a ranking of the multiple vehicle types for the user (220). The one or more parameters can specify how the system 100 is to perform the ranking for the user. In one example, the ranking can be based solely on price, so that Type2 is ranked higher for the user than Type1. In another example, the ranking can be based on ETA, so that Type1 is ranked higher for the user than Type2. Still further, in another example, the ranking can be based on both price and ETA (and other factors, such as weights or predetermined rankings of vehicle types). For example, the ranking can be based on price (with the cheaper vehicle type being ranked higher than the more expensive vehicle type) provided that the cheaper vehicle type does not have an ETA that is greater than a predetermined ETA difference than the ETA of the more expensive vehicle type. For purpose of simplicity, in this example with reference to FIG. 2A, the user's ranking can be configured to be based solely on price, so that Type2 is ranked higher for the user than Type1, as Type2 is cheaper in price for the user than Type1 at this time.

The system 100 can determine whether the user has indicated interest in making a transport request for a first vehicle type (225). In some examples, the system 100 can make this determination based on information received from the client application on the client device. The information can indicate what inputs, if any, the user has inputted via the client application as well as the state of the client application, including the view or information of the last vehicle type the client application has displayed. Depending on implementation, the system 100 can determine if the user has indicated interest in making a transport request for a first vehicle type by (i) determining that information about the first vehicle type has been displayed on the client application for a predetermined duration of time (and/or no input information is provided to the system 100 even though the client application is still running on the client device), or (ii) by receiving, from the client application, information indicating that the user has provided input on the client application make a request for the first vehicle type (but has not yet confirmed the request for the first vehicle type).

If the system 100 determines that the user has not indicated interest in making a transport request, the system 100 can continue to determine a set of information for each of multiple vehicle types at the user's location (e.g., periodically update the information) and transmit the set of information to the client device. In addition, each time the user provides a different pickup location (or if the user changes position over a predetermined distance amount), the client application can provide the location information to the system 100 and the system 100 can again determine the set of information for each of multiple vehicle types for the user. Still further, the system 100 can determine the ranking for the user using the updated set of information.

On the other hand, if the system 100 determines that the user has indicated interest in making a transport request for a first vehicle type, the system 100 can determine if the first vehicle type is the highest ranked vehicle type for the user (230). Based on the user-specific ranking, if the system 100 determines that the user has indicated interest in making a transport request for a vehicle type that is not the highest ranked vehicle type for the user (e.g., the user indicated interest in Type1), the system 100 can generate and provide a notification to the client device that informs or proposes an alternate vehicle type to the user before the user makes or confirms a transport request for the first vehicle type (235). For example, the notification can be automatically generated to include content that explains to the user why the system 100 is proposing an alternate vehicle type for the user.

In one implementation, the notification content can provide contextual information for the user, such as “Request Type2 because it is currently cheaper than Type1!” or if Type2 is the more luxurious vehicle type than Type1, such as in this example, the notification content can state “Upgrade your service right now and request Type2 instead of Type1, and also save money!” Because the user may typically request Type1 when making transport requests (e.g., the majority of the time the user uses the client application) as Type1 is normally cheaper by default than Type2 in a given geographic region (e.g., San Francisco, Calif.), the user may not have considered a better alternative option (in this case, a cheaper and a more luxurious or spacious vehicle type). In this manner, the system 100 can provide the user with information and an opportunity to switch and even upgrade the transport service.

Conversely, if the system 100 determines that the user has indicated interest in making a transport request for a vehicle type that is not the highest ranked vehicle type for the user (e.g., the user indicated interest in Type2), the system 100 can continue with normal operations without providing a notification and wait for the user to make a request for transport. Regardless of which vehicle type the user chooses, if the user makes a transport request using the client application for whichever vehicle type the user prefers, the system 100 can receive the transport request (240) and then can process the transport request to arrange the transport service for the user for the user-specified vehicle type by selecting a driver to provide the transport service for the user (245).

As an addition or an alternative, the system 100 can determine the ranking of the vehicle types for the user after determining that the user has indicated interest in making a transport request for a first vehicle type (e.g., step 220 can be performed after step 225 and/or can be performed as part of step 230). In such an example, the system 100 can determine the set of information about each of the multiple vehicle types at the time the system 100 determines that the user has indicated interest in making a transport request for a first vehicle type. The system 100 can then determine the ranking based on this set of information so that the ranking is based on the current or most up-to-date set of information for the user.

Still further, in another implementation, one or more steps described in FIG. 2A can be performed by the client application using resources of the client device. For example, once the system 100 determines and transmits the set of information about each of multiple vehicle types to the client application on the client device, the client application can perform steps 220 through 235. In this example, the client application can include instructions that cause the client device to determine the ranking for the user based on the received set of information from the system 100 and can determine, based on user input (or lack of user input) on the client application, whether the user has indicated interest in requesting transport for a first vehicle type. The client application can determine if the first vehicle type is the highest ranked vehicle type, and if not, the client application can display a notification informing or proposing to the user to request a different vehicle type, e.g., the highest ranked vehicle type for the user. The system 100 can then receive a request for transport for a specified vehicle type from the client application when the user makes the request.

FIG. 2B illustrates another example method for providing a notification to a client device based on real-time conditions. A method such as described by an example of FIG. 2B can be implemented using, for example, components described with an example of FIG. 1. Accordingly, references made to elements of FIG. 1 are for purposes of illustrating a suitable element or component for performing a step or sub-step being described.

According to some examples, one or more steps described in FIG. 2B can be performed as an addition to or as an alternative to one or more steps described in FIG. 2A. For example, while not shown in FIG. 2B, the system 100 can receive the current location information or a pickup location information of a user from a client device, such as described in step 210 of FIG. 2A, and can determine a set of information about each of multiple vehicle types for the user based on the received location information and real-time conditions, such as described in step 215 of FIG. 2A. The system 100 can provide the set of information to the client device to enable the client application to display at least some information about the transport service to the user. The user can operate the client application to view which vehicle types are available at the user's location, view information about individual vehicle types, switch between vehicle types, specify a pickup location (and/or a destination location), make a request for transport, and/or perform other operations related to a transport service.

Referring to FIG. 2B, the system 100 can receive a request for transport from the client device when the user makes the request on the client application (255). The request can include the user's location information (e.g., a GPS data point) and a specified vehicle type (e.g., a first vehicle type of multiple vehicle types that is available for providing transport service for the user at the user's location). The user's location information can correspond to the current location of the user as determined by the GPS receiver of the client device or the pickup location specified by the user. Once the system 100 receives the request, the system 100 can determine whether the first vehicle type is the highest ranked vehicle type for the user (255). In one example, the system 100 can make this determination based on the most recently determined user-specific ranking of vehicle types for the user. As described with respect to FIG. 1, the system 100 can determine the ranking for the user based on at least some of a set of information about each of multiple vehicle types that is specific to the user's location. The set of information can include a price of each vehicle type at the user's location and/or an ETA of each vehicle type to the user's location.

According to variations, the system 100 can (i) determine the ranking for the user each time the user specifies a different location information on the client application (before making the request), (ii) determine the ranking for the user periodically, (iii) determine the ranking for the user every time at least some of the set of information is changed or updated, and/or (iv) determine the ranking when the request for transport is received. In this manner, depending on implementation, the system 100 can determine the ranking for the user even before the request for transport is received (e.g., before step 250), concurrently when the request for transport is received (e.g., during step 250), or in response to receiving the request for transport (e.g., after step 250). For example, if the system 100 determines the ranking in response to receiving the request for transport, once the user makes the request using the client application (e.g., requests the service and confirms the request), the client application can display a user interface indicating that the request is being processed. During this time, the system 100 can determine the ranking for the user.

If the system 100 determines that the first vehicle type is the highest ranked vehicle type for the user, the system 100 can process the request by arranging a transport service for the user for the first vehicle type, e.g., the type as requested by the user in the request (260). The system 100 can arrange the transport service by selecting a driver from a pool of available drivers of the specified first vehicle type to provide the transport service for the user. On the other hand, if the system 100 determines that the first vehicle type is not the highest ranked vehicle type for the user, the system 100 can provide a notification to the client device informing the user that the request is to be processed for an alternate vehicle type (e.g., a second vehicle type that is ranked higher than the first vehicle type for the user) as opposed to the first vehicle type that was originally requested by the user (265). The notification can include content that explains to the user why the request is to be processed or is being processed for the alternate vehicle type. In one example, the system 100 can also concurrently process the request for the alternate vehicle type by arranging the transport service for the user.

According to another example, such as described in FIG. 2B, the system 100 can determine whether the user has confirmed the highest ranked vehicle type or has allowed a predetermined duration of time to elapse (e.g., has not confirmed or rejected the proposed vehicle type change for the user's request for the predetermined duration of time) (270). In this example, the client application can display the notification along with one or more features, such as a dynamic timing feature and/or a selection feature(s) (e.g., display an interactive notification). The notification can include a selectable feature to confirm the proposed alternate vehicle type change for the user's request for transport, a selectable feature to reject the proposed vehicle type change, and/or a selectable feature to cancel the request for transport entirely. Still further, in one example, the notification can also include a dynamic timing feature separate from or as part of another feature (e.g., as part of the selectable feature to reject the proposed vehicle type change) that indicates the predetermined duration of time. This duration, such as ten seconds, can indicate to the user the amount of time the user has to revert back to the previously requested vehicle type (e.g., the first vehicle type), as opposed to the system-proposed alternate vehicle type.

If the user confirms the alternate vehicle type or does not reject the proposed vehicle type change during the duration of time, the system 100 can proceed with driver selection process (e.g., arrange the transport service) for the user for the alternate vehicle type (275). On the other hand, if the user rejects the proposed vehicle type change, the system 100 can process the request to arrange the transport service for the user for the originally specified first vehicle type. Alternatively, the user can cancel the request for transport at any time and end the process described in FIG. 2B.

As described in FIGS. 2A and 2B, by proposing a higher ranked or highest ranked alternate vehicle type to the user, the user can receive the benefit of an upgrade to the transport service and be notified of a beneficial vehicle type (e.g., one that is cheaper, faster, etc.) that the user may have overlooked. In addition, a price for a first vehicle type in a given sub-region may have increased significantly due to the lack of available drivers of that vehicle type in that given sub-region and/or due to a large number of users that are operating the client applications in that given sub-region, while the price for other vehicle types may have remained the same or have increased relatively smaller compared to the first vehicle type. By proposing alternative vehicle types, the system 100 can enable the prices to be more balanced out by potentially causing users to request the alternate vehicle types as opposed to the first vehicle type (e.g., enable better allocation of supply).

Use Case Examples

Use case examples are described below to illustrate different ranking methodologies used by the service arrangement system, such as described in FIGS. 1 through 2B. As described with respect to FIG. 1, depending on implementation, the service arrangement system can determine a user-specific ranking for individual users based on one or more parameters that specifies how the ranking is to be determined by the system. Although three or more vehicle types may be available for a user at the user's location, for purpose of simplicity, use case examples are described below for two vehicle types.

For example, the use case examples can describe to two vehicle types that are available at a user's location—Type1, which is a low-cost vehicle type, and Type2, which is a more expensive vehicle type than Type1 (such as a luxury vehicle type or a larger six-seater vehicle type). At the user's location (e.g., in the sub-region or geographic region of the user's location), for example, the default price for Type1 can be $5 minimum, $2 base amount, $0.25/minute, and $1/mile, while the default price for Type2 can be $8 minimum, $3 base amount, $0.45/minute, and $2/mile.

Use Case 1: If the current price for each of Type1 and Type2 are at the respective default prices so that the price multiplier is 1× for each vehicle type (e.g., there is no dynamic increase in price), no ranking is determined for the user by the system. The system may be configured to determine the ranking only when there is dynamic adjustment to a price of a vehicle type. By not determining the ranking for a user during normal operational conditions (e.g., no price adjustment), the system can reduce the amount of computation performed by system components, such as the processor(s) and memory resource(s).

Use Case 2: If the price(s) of Type1 and/or Type2 are dynamically adjusted so that the current prices for Type1 and Type2 are equal or substantially equal (e.g., the price of one is within 80% or within 90% of the price of the other), the system can determine the ranking based on a predetermined hierarchy of vehicle types. For example, the predetermined hierarchy can rank the vehicle types by default price (which can correspond to ranking the vehicle types by luxury and/or size), so that Type2 is ranked higher than Type1. In this instance, the system can rank Type2 higher than Type1 for the user, so that if the user indicated interest (or made a request for transport) for Type1, the system can transmit a notification to propose to the user to request Type2, e.g., the higher ranked (or highest ranked) vehicle type for the user that is more luxurious and/or more spacious than the low-cost vehicle type option the user may have requested. In this manner, the predetermined hierarchy can cause the system to only propose “upgrades” to the user when the prices are equal or substantially equal (e.g., in a unilateral direction).

Use Case 3: If the price(s) of Type1 and/or Type2 are dynamically adjusted so that the current prices for Type1 and Type2 are equal or substantially equal, the system can compare the ETAs of Type1 and Type2 and then determine the ranking based on the ETAs. If Type1 has an ETA of 4 minutes to the user's location and Type2 has an ETA of 6 minutes to the user's location, for example, the system can rank the vehicle types so that Type1 is ranked higher than Type2. As an addition or an alternative, if the system also uses a predetermined hierarchy of vehicle types, as described in Use Case 2, the system can rank the vehicle types so that Type1 is ranked higher than Type2 only when the ETA difference of Type1 as compared to Type2 is equal to or greater than a threshold ETA. In this manner, the lower ranked vehicle type (e.g., Type1) as specified in the predetermined hierarchy can be ranked higher for the user if the ETA for Type1 is significantly shorter than the ETA of Type2 (thereby reducing the user's wait time for a transport service).

Use Case 4: If the price(s) of Type1 and/or Type2 are dynamically adjusted so that the current price for Type1 is higher than the current price for Type2 (e.g., and not substantially equal), the system can rank Type2 to be higher than Type1. This ranking can be used to propose an automatic upgrade to the user if the user considered requesting Type1, the low-cost option, as opposed to Type2, which is a more luxurious vehicle type than Type 1. The user can be notified that the user can request the more luxurious vehicle type without having to pay additional costs.

Use Case 5: The default price of Type2 can be higher than the default price of Type1 in a given region, such as described in these examples. If the price(s) of Type1 and/or Type2 are dynamically adjusted so that the current price for Type2 is significantly higher than the current price for Type1 (e.g., Type2 is 2 or more times more expensive than Type1, such as when Type2 has a price multiplier of 1.5× or 2× or 3×, while Type1 has a price multiplier of 1×), the system can rank Type1 to be higher than Type 2. In this case, even though Type1 can be seen as a “downgrade” as opposed to an “upgrade” because it is the low-cost option, the system can inform the user of the lower-cost option in such an instance to enable the user to potentially save money. As an addition or an alternative, the system can be configured to perform the ranking in the described manner only when the difference in price of Type1 and Type2 is equal to or greater than a threshold difference. As another alternative, the system can be configured to perform the ranking in the described manner (e.g., rank Type1 higher than Type2) only if the ETA of Type1 is shorter than the ETA of Type2, or if the ETA of Type1 is shorter than the ETA of Type2 by a threshold ETA difference amount.

Use Case 6: The ranking in another example can be based solely on ETA or based on ETA if the current price for each of Type1 and Type2 are at the respective default prices. The notification can include content about the ETA or can include content describing the difference in ETAs for the user (e.g., “Request Type2 if you need a ride within the next minute” or “Type2 has five minute shorter wait time than Type1”). As an alternative or an addition, the system can propose the more expensive vehicle type option, Type2, if the ETA for Type1 is significantly higher than the ETA for Type2, or if the ETA for Type1 is significantly higher than the ETA for Type1 by a threshold ETA difference amount.

While the use case examples are described using two vehicle types for a user, the system can determine the ranking of vehicle types of three of more vehicle types in similar manners. For example, at the user's location, a third vehicle type, Type3, can be the more expensive vehicle type and can have a default price of $15 minimum, $8 base amount, $0.65/minute, and $3.75/mile. In addition, three vehicle types can have a predetermined hierarchy based on default prices, with the most expensive (and/or most luxurious or most spacious) vehicle type being ranked higher than the cheapest, low-cost vehicle type. The concepts for determining ranking based on price, ETA, and/or a predetermined hierarchy can extend to ranking the three vehicle types.

Hardware Diagram

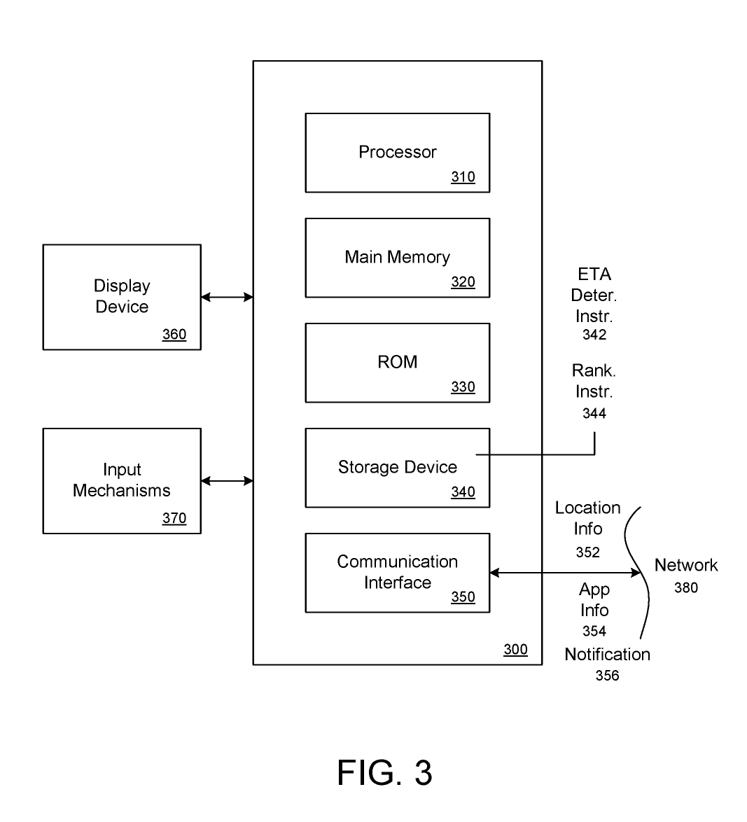

FIG. 3 is a block diagram that illustrates a computer system upon which examples described herein may be implemented. For example, in the context of FIG. 1, the system 100 may be implemented using a computer system such as described by FIG. 3. The system 100 may also be implemented using a combination of multiple computer systems as described by FIG. 3.

In one implementation, the computer system 300 includes processing resources, such as one or more processors 310, a main memory 320, a read-only memory (ROM) 330, a storage device 340, and a communication interface 350. The computer system 300 includes at least one processor 310 for processing information and the main memory 320, such as a random access memory (RAM) or other dynamic storage device, for storing information and instructions to be executed by the processor 310. The main memory 320 also may be used for storing temporary variables or other intermediate information during execution of instructions to be executed by the processor 310. The computer system 300 may also include the ROM 330 or other static storage device for storing static information and instructions for the processor 310. The storage device 340, such as a magnetic disk or optical disk, is provided for storing information and instructions. For example, the storage device 340 can correspond to a computer-readable medium that stores ETA determine instructions 342 and ranking instructions 344 for performing operations discussed with respect to FIGS. 1 through 3. In addition, the storage device 340 can include other instructions, such as instructions to implement the client manager or the dispatch sub-system, and other data, such as data stored in the databases described with respect to FIG. 1.

The communication interface 350 can enable the computer system 300 to communicate with one or more networks 380 (e.g., cellular network) through use of the network link (wirelessly or using a wire). Using the network link, the computer system 300 can communicate with a plurality of devices, such as the mobile computing devices of the users and service providers. According to some examples, the computer system 300 can receive location information 352 and application information 354 from the mobile computing devices of the clients and service providers via the network link, such as described by FIGS. 1 through 2B. In one example, the processor 310 can use the location information 352 of a user from a client device and determine a ranking for the user. Based on the ranking, the processor 310 can determine if the user has indicated interest (or has made a request) for a particular vehicle type and if that vehicle type is the highest ranked vehicle type for that user. The processor 310 can transmit, via the communication interface 350 over the network 380, a notification 356 to the client device to inform the user of an alternative, more beneficial vehicle type (e.g., the highest ranked vehicle type) if the user has indicated interest for a vehicle type that is not the highest ranked vehicle type for the user.

The computer system 300 can also include a display device 360, such as a cathode ray tube (CRT), an LCD monitor, or a television set, for example, for displaying graphics and information to a user. An input mechanism 370, such as a keyboard that includes alphanumeric keys and other keys, can be coupled to the computer system 300 for communicating information and command selections to the processor 310. Other non-limiting, illustrative examples of the input mechanisms 370 include a mouse, a trackball, touch-sensitive screen, or cursor direction keys for communicating direction information and command selections to the processor 310 and for controlling cursor movement on the display 360.

Examples described herein are related to the use of the computer system 300 for implementing the techniques described herein. According to one example, those techniques are performed by the computer system 300 in response to the processor 310 executing one or more sequences of one or more instructions contained in the main memory 320. Such instructions may be read into the main memory 320 from another machine-readable medium, such as the storage device 340. Execution of the sequences of instructions contained in the main memory 320 causes the processor 310 to perform the process steps described herein. For example, the processor 310 can execute the ETA determine instructions 342 to determine the ETAs of individual vehicle types to a user's location and the ranking instructions 344 to determine the user-specific ranking for that user based on the determined ETAs and/or other information, such as the prices of the vehicle types. In alternative implementations, hard-wired circuitry may be used in place of or in combination with software instructions to implement examples described herein. Thus, the examples described are not limited to any specific combination of hardware circuitry and software.

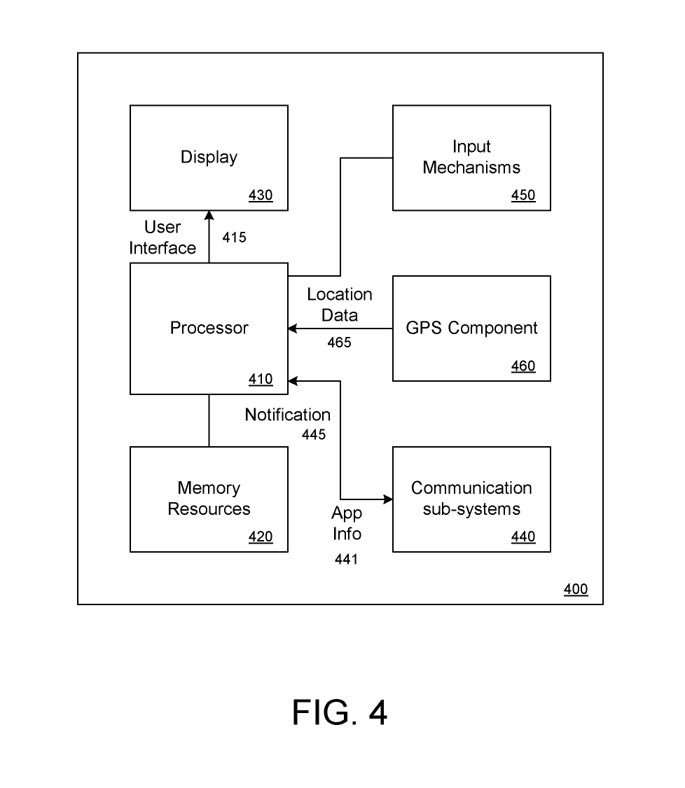

FIG. 4 is a block diagram that illustrates a mobile computing device upon which examples described herein may be implemented. In one example, a computing device 400 may correspond to a mobile computing device, such as a cellular device that is capable of telephony, messaging, and data services. The computing device 400 can correspond to a client device or a driver device. Examples of such devices include smartphones, handsets or tablet devices for cellular carriers. The computing device 400 includes a processor 410, memory resources 420, a display device 430 (e.g., such as a touch-sensitive display device), one or more communication sub-systems 440 (including wireless communication sub-systems), input mechanisms 450 (e.g., an input mechanism can include or be part of the touch-sensitive display device), and one or more location detection mechanisms (e.g., GPS component) 460. In one example, at least one of the communication sub-systems 440 sends and receives cellular data over data channels and voice channels.

The processor 410 is configured with software and/or other logic to perform one or more processes, steps and other functions described with implementations, such as described by FIGS. 1 through 3, and elsewhere in the application. The processor 410 is configured, with instructions and data stored in the memory resources 420, to operate a service application as described in FIGS. 1 through 3, such as a client application for a client device or a driver application for a driver device. For example, instructions for operating the service application in order to display various user interfaces can be stored in the memory resources 420 of the computing device 400.

A user, for example, can operate a mobile computing device (such as the computing device 400) to operate a client application. The GPS component 460 can determine location information, such as the current location data point 465 of the computing device 400. The location data point 465 can be wirelessly transmitted to the service arrangement system via the communication sub-systems 440 periodically and/or as part of application information 441, such as described in FIGS. 1 through 3. The service arrangement system can receive the location data point 465 from the computing device 600 (or a user-specific location data point corresponding to a selected pickup location) and determine a set of information about each of multiple vehicle types for the user based on the location data point 465. The system can also transmit a notification 445 to the computing device 400 via the communication sub-systems 440 if the system determines that the user has indicated interest in making a request for a vehicle type that is not the highest ranked vehicle type for that user. The notification 445 can be processed by the processor 410 to provide the notification 445 as content as part of a user interface 415 on the display 430.

For example, the processor 410 can provide a variety of content to the display 430 by executing instructions and/or applications that are stored in the memory resources 420. One or more user interfaces 415 can be provided by the processor 410, such as a user interface for the service application. While FIG. 4 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method of arranging a transport service for a user, the method being performed by a computing system and comprising:
receiving, at the computing system over one or more networks, location information from a client device, the client device being operated by a user;
based on the received location information, (i) determining a set of information about each of at least two or more vehicle types by accessing one or more databases accessible by the computing system, (ii) transmitting, over the one or more networks to the client device, the set of information about each of the at least two or more vehicle types, and (iii) determining, for the user, a ranking of at least a first vehicle type and a second vehicle type of the at least two or more vehicle types based on one or more predetermined parameters and on at least some of the set of information about each of the at least two or more vehicle types;
determining, at the computing system, that the user has indicated interest in making a transport request for the first vehicle type, wherein the second vehicle type is ranked higher than the first vehicle type; and
in response to determining that the user has indicated interest in making a transport request for a vehicle type that is not the highest ranked vehicle type for the user, transmitting, from the computing system to the client device, a notification suggesting that the user make a transport request for the second vehicle type as opposed to the first vehicle type.

2. The method of claim 1, wherein determining the set of information about each of the at least two or more vehicle types includes determining a price for each of the at least two or more vehicle types and determining an estimated time of arrival (ETA) of each of the at least two or more vehicle types to a location corresponding to the received location information.

3. The method of claim 2, further comprising:
in response to receiving the location information from the client device, determining a sub-region from a plurality of sub-regions that the location is positioned within.

4. The method of claim 3, wherein the price for each of the at least two or more vehicle types corresponds to a multiplier of a default price for that respective vehicle type, and wherein determining the price includes determining the price for each of the at least two or more vehicle types in the sub-region.

5. The method of claim 4, wherein the one or more parameters specifies that the ranking is to be performed only when the multiplier of the default price for at least one of the two or more vehicle types is greater than or equal to a threshold multiplier.

6. The method of claim 3, wherein determining the ETA of each of the at least two or more vehicle types includes determining, for each of the at least two or move vehicle types, (i) a position of each of one or more available drivers of that vehicle type in the sub-region, (ii) a route for each of the one or more available drivers of that vehicle type from the respective position of each of the one or more available drivers to the location, (iii) the ETA of each of the one or more available drivers based on the respective route, and (iv) determining the shortest ETA, the longest ETA, or the averaged ETA of the one or more available drivers.

7. The method of claim 2, wherein the one or more parameters specifies that the ranking is to be based on at least (i) the price for each of the at least two or more vehicle types, (ii) the ETA of each of the at least two or more vehicle types, (iii) a predetermined ranking of the at least two or more vehicle types, (iv) a price difference threshold, or (v) a time difference threshold.

8. The method of claim 1, wherein determining that the user has indicated interest includes (i) determining that a client application on the client device is displaying information about the first vehicle type for a predetermined duration of time, or (ii) receiving, from the client application, information indicating that the user has provided input on the client application make a request for the first vehicle type, but has not yet confirmed the request for the first vehicle type.

9. A non-transitory computer-readable medium storing instructions that, when executed by a processor of a computing system, causes the computing system to:
receive, at the computing system over one or more networks, location information from a client device, the client device being operated by a user;
based on the received location information, (i) determine a set of information about each of at least two or more vehicle types by accessing one or more databases accessible by the computing system, and (ii) determine, for the user, a ranking of at least a first vehicle type and a second vehicle type of the at least two or more vehicle types based on at least some of the set of information about each of the at least two or more vehicle types;
determine, at the computing system, that the user has indicated interest in making a transport request for the first vehicle type based on information received from the client device corresponding to user input, wherein the second vehicle type is ranked higher than the first vehicle type; and
in response to determining that the user has indicated interest in making a transport request for a vehicle type that is not the highest ranked vehicle type for the user, transmit, from the computing system to the client device, a notification suggesting that the user make a transport request for the second vehicle type as opposed to the first vehicle type.

10. The non-transitory computer-readable medium of claim 9, wherein the instructions cause the computing system to determine the set of information about each of the at least two or more vehicle types by determining a price for each of the at least two or more vehicle types and determining an estimated time of arrival (ETA) of each of the at least two or more vehicle types to a location corresponding to the received location information.

11. The non-transitory computer-readable medium of claim 10, wherein the instructions further cause the computing device to:
in response to receiving the location information from the client device, determine a sub-region from a plurality of sub-regions that the location is positioned within; and
wherein the price for each of the at least two or more vehicle types corresponds to a multiplier of a default price for that respective vehicle type.

12. The non-transitory computer-readable medium of claim 11, wherein the instructions cause the computing device to determine the price by determining the price for each of the at least two or more vehicle types in the sub-region.

13. The non-transitory computer-readable medium of claim 11, wherein the one or more parameters specifies that the ranking is to be performed only when the multiplier of the default price for at least one of the two or more vehicle types is greater than or equal to a threshold multiplier.

14. The non-transitory computer-readable medium of claim 10, wherein the one or more parameters specifies that the ranking is to be based on at least (i) the price for each of the at least two or more vehicle types, or (ii) the ETA of each of the at least two or more vehicle types.

15. The non-transitory computer-readable medium of claim 9, wherein the instructions cause the computing device to determine that the user has indicated interest by (i) determining that a client application on the client device is displaying information about the first vehicle type for a predetermined duration of time, or (ii) receiving, from the client application, information indicating that the user has provided input on the client application make a request for the first vehicle type, but has not yet confirmed the request for the first vehicle type.

16. A computer system comprising:
a network service provided by one or more servers, wherein the network service:
obtains, in real-time or near real-time, location information from a plurality of mobile computing devices, each mobile computing device being associated with a user that is at least one of a requester or service provider;
for at least a first requester in a given region, identifies, from the location information, multiple service providers that are available to provide transport services for the first requester, the multiple service providers providing multiple types service;
determines one or more parameters for evaluating each of the multiple service providers based at least in part on the location information;
determines a ranking of service providers for a given duration of time based at least in part on the one or more parameters; and
generates a suggestion for a particular service type for the mobile computing device associated with the requester, the suggestion reflecting the determined ranking.

17. The system of claim 16, wherein the system comprises:
the service application running on each of the plurality of mobile computing devices.

18. The system of claim 16, wherein the network service determines the suggestion before the requester initiates a request for transport.

19. The system of claim 16, wherein the one or more parameters include an estimated time of arrival.

20. The system of claim 16, wherein the one or more parameters include a number of service providers of each of the multiple service types in the given region.
